(19) United States
(12) Patent Application Publication
(10) Pub. No.: US 2024/0385892 A1
(43) Pub. Date: Nov. 21, 2024

(54) DEPLOYMENT OF AN ACCELERATION SERVICE IN A COMPUTING ENVIRONMENT

(71) Applicant: Nokia Solutions and Networks Oy, Espoo (FI)

(72) Inventors: Dora BOVIZ, Massy (FR); Lei XU, Hangzhou (CN); Kevin DOMBKOWSKI, Oswego, IL (US); Eric MERMILLIOD, Massy (FR); Thierry BESSIS, Massy (FR); David BAIETTO, Dallas, TX (US); Alberto CONTE, Massy (FR); Qinfeng ZHOU, Hangzhou (CN)

(21) Appl. No.: 18/576,579

(22) PCT Filed: Jul. 15, 2021
(86) PCT No.: PCT/CN2021/106591

§ 371 Date: Jan. 4, 2024

(51) Int. Cl. G06F 9/50

(52) U.S. Cl. CPC G06F 9/505

(57) ABSTRACT

Example embodiments of the present disclosure relate to deployment of an acceleration service in a computing environment. A first service instance is deployed within a first container in a computing environment based on configuration information related to a first acceleration service, the first acceleration service to be associated with one or more functional components. A first functional component instance for a first functional component of the one or more functional components is deployed within the first service instance. At least a part of resources of the first container is mapped to the first functional component instance based on a resource requirement of the first functional component. Data related to the first functional component instance are to be processed by the first service instance using at least the part of resources mapped to the first functional component instance.

### FIELD

Embodiments of the present disclosure generally relate to the field of computing technology and in particular, to deployment of an acceleration service in a computing environment.

### BACKGROUND

An acceleration service is a framework to accelerate processing of workload from an application. The acceleration service may be allowed to use certain infrastructure resources to achieve the acceleration. An acceleration service may generally be associated with multiple functional components of one or more applications, and the operation of the functional components is coupled with the underlying resources of the acceleration service. Atypical example of acceleration service is event machine (EM), which is used in real-time environments over an operating system (such as Linux) to bypass the system scheduler and its interruptions to achieve the purpose of acceleration. EM comprises a run-to-completion EM scheduler associated with EM dispatchers on general processing units (CPUs) or other signal/data processing entities, to allow applications configured to use EM software libraries.

Conventionally, due to the coupling between infrastructure resources and functional components, the deployment of acceleration services has limited flexibility and thus improvements are needed in this regard.

### SUMMARY

The scope of protection sought for various embodiments of the invention is set out by the independent claims. The embodiments/examples and features, if any, described in this specification that do not fall under the scope of the independent claims are to be interpreted as examples useful for understanding various embodiments of the invention.” Please note that the term “embodiments” or “examples” should be adapted accordingly to the terminology used in the application, i.e. if the term “examples” is used, then the statement should talk of “examples” accordingly, or if the term “embodiments” is used, then the statement should talk of “embodiments” accordingly.

In general, example embodiments of the present disclosure provide a solution for deployment of an acceleration service in a computing environment. Embodiments that do not fall under the scope of the claims, if any, are to be interpreted as examples useful for understanding various embodiments of the disclosure.

In a first aspect, there is provided a method. The method comprises deploying a first service instance within a first container in a computing environment based on configuration information related to a first acceleration service, the first acceleration service to be associated with one or more functional components; deploying a first functional component instance for a first functional component of the one or more functional components within the first service instance; mapping at least a part of resources of the first container to the first functional component instance based on a resource requirement of the first functional component; and causing data related to the first functional component instance to be processed by the first service instance using at least the part of resources mapped to the first functional component instance.

In a second aspect, there is provided a system. The system comprises at least one processor; and at least one memory including computer program code; where the at least one memory and the computer program code are configured to, with the at least one processor, cause the first device to deploying a first service instance within a first container in a computing environment based on configuration information related to a first acceleration service, the first acceleration service to be associated with one or more components; deploying a first functional component instance for a first functional component of the one or more functional components within the first service instance; mapping at least a part of resources of the first container to the first functional component instance based on a resource requirement of the first functional component; and causing data related to the first functional component instance to be processed by the first service instance using at least the part of resources mapped to the first functional component instance.

In a third aspect, there is provided an apparatus. The apparatus comprises means for deploying a first service instance within a first container in a computing environment based on configuration information related to a first acceleration service, the first acceleration service to be associated with one or more functional components; deploying a first functional component instance for a first functional component of the one or more functional components within the first service instance; mapping at least a part of resources of the first container to the first functional component instance based on a resource requirement of the first functional component; and causing data related to the first functional component instance to be processed by the first service instance using at least the part of resources mapped to the first functional component instance.

In a fourth aspect, there is provided a computer readable medium. The computer readable medium comprises program instructions for causing an apparatus to perform at least the method according to the first aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example computing environment in which example embodiments of the present disclosure can be implemented;

FIG. 2 illustrates a schematic block diagram of an example framework of an event machine (EM);

FIG. 3 illustrates example architecture for service deployment in a computing environment according to some example embodiments of the present disclosure;

FIG. 4 illustrates an example structure of elements of an application associated with an EM according to some example embodiments of the present disclosure;

FIG. 5 illustrates an example of deconstruction of an application and a specification for an application associated with an EM according to some example embodiments of the present disclosure;

FIG. 6 illustrates an example deployment of functional components of applications within an EM instance according to some example embodiments of the present disclosure;

FIG. 7 illustrates an example of implementing the service instance in a physical worker node according to some example embodiments of the present disclosure;

FIG. 8 illustrates an example of logic implementations of entities according to some example embodiments of the present disclosure;

FIG. 9 illustrates a signaling flow of deploying or scaling out a functional component according to some example embodiments of the present disclosure;

FIG. 10 illustrates a signaling flow of removing or scaling in a functional component according to some example embodiments of the present disclosure;

FIG. 11 illustrates a signaling flow of deploying in a service instance of an acceleration service according to some example embodiments of the present disclosure;

FIG. 12 illustrates a signaling flow of removing or scaling in a service instance of an acceleration service according to some example embodiments of the present disclosure;

FIG. 13 illustrates a signaling flow for an example according to some example embodiments of the present disclosure;

FIG. 14 illustrates a simplified block diagram of a device that is suitable for implementing example embodiments of the present disclosure; and

FIG. 15 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an JAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoTP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an JAB node (e.g., a relay node). In the following description, the terms “terminal device”, “communication device”, “terminal”, “user equipment” and “UE” may be used interchangeably.

### Example Environment

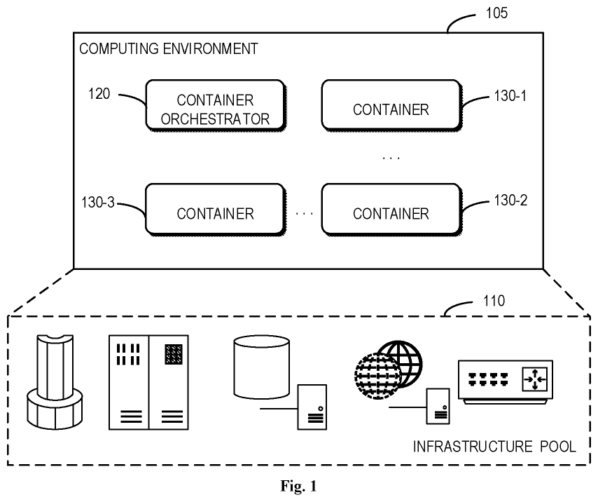

FIG. 1 shows an example computing environment 105 in which example embodiments of the present disclosure can be implemented. The communication environment 105 is built on top of an infrastructure pool 110 through virtualization technologies. The infrastructure pool 110 may include various types of computing and storage resources, e.g., servers, networks, storage, database, and the like.

In some example embodiments, the computing environment 105 may include a cloud computing environment. Cloud computing is one of the fastest growing trends in computer technology which involves the delivery of hosted services over a network. The cloud computing environment can enable convenient, on-demand network access to the resources of the infrastructure pool 110 that can be provisioned and released quickly, dynamically, and with minimal manual management efforts and human interactions with the service providers.

In some example embodiments, the computing environment 105 may be operated by employing container-based virtualization technologies. An example of the container-based virtualization may include Kubernetes container virtualization. In addition to Kubernetes, a variety of other virtualization techniques can also be employed.

The computing environment 105 may include a container orchestrator 120 which is configured to orchestrate containers, such as deploying, scaling, and removing containers in the computing environment 105. One or more containers such as containers 130-1, 130-2, and 130-3 may be deployed on-demand in the computing environment, to implement one or more tasks. Each container may consume a part of the resources in the infrastructure pool 110 to support its operation.

Typically, a container is deployed in the computing environment in order to implement a service. A service that is actually provisioned or initiated in the computing environment may be referred to as an “instance” of the service or a “service instance” for short. A service may be considered as an application platform running to implement specified functionalities.

It should be appreciated that the number of computing nodes, the number of services, and the arrangement of the services across the computing nodes in FIG. 1 are provided for the purpose of illustration only. The computing environment may comprise one or more other computing nodes, and the number of services may be different and arranged in other manners.

### Example Acceleration Service

In some cases, an acceleration service may be associated with one or more functional components of one or more applications, and the operation of the functional components is coupled with the underlying resources of the service platform. As some examples, the functional components may include shared libraries to be loaded by the acceleration service, processes or daemons communicating with the acceleration service using inter-process communication (IPC), and the like. Depending on the acceleration services and applications, other functional components may also be possible.

As a typical example of acceleration service, event machine (EM) is introduced here. The concept of EM is a framework and an architectural abstraction of an event driven, multicore optimized, processing concept which is originally developed for the networking data plane.

EM comprises a run-to-completion EM scheduler associated with EM dispatchers on general processing units (CPUs) or other signal processing entities, to allow applications configured to use EM software libraries. It takes events as inputs and distributes to applicative Event Objects (EO), also called “Execution Objects of Application.” An EO may be embodied as a shared library to be loaded by the EM. One or more EOs may be configured for a same application. EM may be considered as a middleware platform which provides services to software applications beyond those available from the operating system. EM may offer an easy programming concept for scalable and dynamically load balanced multicore applications with a very low overhead run-to-completion principle.

Each EO can run events from one or more Event Queues (EQ) and EQs are grouped to event queue groups (EQGs). An EQG can specify the affinity between EQs and CPU cores wherein process EQs' events. The scheduler and a dispatcher in a core of a given EM take events from affined EQs and call their corresponding functions to process the events. EM can perform priority scheduling based on the priorities of EQs.

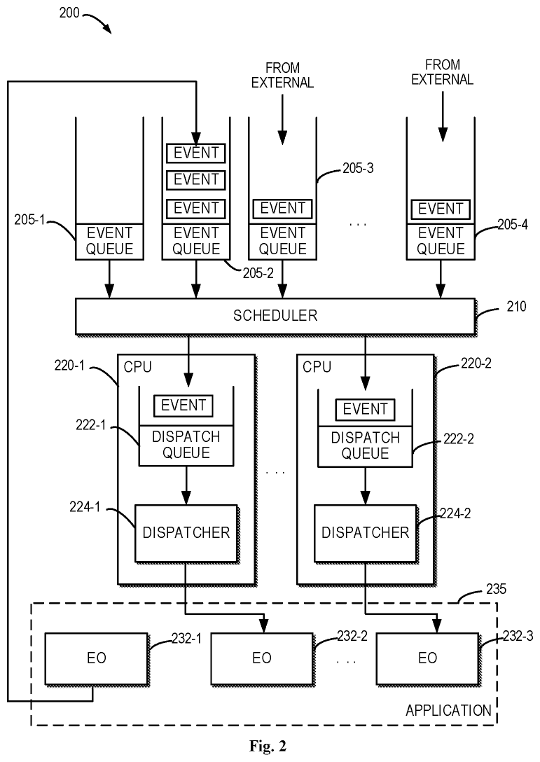

FIG. 2 illustrates a schematic block diagram of an example framework of an EM 200. The EM 200 is configured to handle events related to one or more EOs such as EOs 232-1, 232-2, 232-3 (collectively or individually referred to as EOs 232). In the illustrated example, the EOs 232 are configured for a same application 235. In some other examples, EOs from more than one application may be associated with the same EM 200.

The EM 200 comprises a scheduler 210 and one or more dispatchers in one or more CPUs, such as a dispatcher 224-1 in a CPU 220-1 and a dispatcher 224-2 in a CPU 220-2. The dispatcher 224-1 and dispatcher 224-2 may be collectively or individually referred to as dispatchers 224, and the CPU 220-1 and CPU 220-3 may be collectively or individually referred to as CPUs 220.

Several parameters need to be specified to describe how the applications presented in the form of EOs 232 are called within the framework of the EM 200. An event is an application specific piece of data (such as a message or a network packet) describing workload to do. An event may be issued from an EO 232 or received from external and is processed in the core by calling a corresponding function of an EO 232. Thus, each event is related to an EO 232. All processing in EM must be triggered by an event. Events are sent to asynchronous application specific queues, such as Event Queues (EQs) 205-1, 205-2, 205-3, 205-4 (collectively or individually referred to as event queues or EQs 205). In some example embodiments, two or more EQs 205 may be grouped to an event queue group (EQG). An individual EQ or an EQG may specify affinity between EQs and CPU cores that process events related to the EQs.

A dispatcher loop is run by a single thread on each core of the CPU 220 (“core” is used here to refer to a core or one hardware thread on multi-threaded cores). The dispatcher 224 on each core interfaces with the scheduler 210 and asks for an event to process. The scheduler 210 then evaluates the state of the EQs 205 and gives the highest priority event available to the requesting dispatcher 224. The dispatcher 224 has a corresponding dispatch queue (a dispatch queue 222-1 for the dispatcher 224-1 and a dispatch queue 222-2 for the dispatcher 224-2). The dispatch queue 222-1 and dispatch queue 222-2 are collectively or individually referred to as dispatch queues 222. The events scheduled from the scheduler 210 are included into the corresponding dispatch queue 222 for the dispatcher 224.

The dispatcher 224 looks up which EO 232 owns the EQ 205 that the event came from and calls the registered receive function of the EO 232 to deliver the event for processing. When the event has been handled, the processing result may be passed to an EO 232 or to an external entity through the function returns of the called EO. Then the dispatcher 224 on that core may continue to request another event from the scheduler 210 and deliver it to the corresponding EO 232. The described scenario happens in parallel on all cores of CPUs running the EM 200.

The EM has been designed to be highly efficient, operating in a run-to-completion manner on each participating core with neither context switching nor pre-emption slowing down the event processing loops. The EM can run on bare metal for better performance or under an operating system with special arrangements (e.g. one thread per core with thread affinity).

The concept of EM has been employed in various use cases. One of the example use cases is for telecommunications. For example, the fifth generation (5G) technology introduces new use cases with phase 2, as well as a very large set of radio cases from Frequency Range 1 (FR1) Frequency Division Duplex (FDD) to FR2 Time Division Duplex (TDD) which allows all frequency bands to be addressed with multiple radio generations and antenna capabilities. In addition, the hardware platforms for 5G RAN multiply over time both in hardware-based infrastructure (e.g., for Cloud RAN) and new customized hardware platforms. Such diversity in 5G data unit (DU) deployment context calls for higher level of flexibility and adaptability of application configuration with the EM, so that benefits of EM are accommodated to the dynamic management of cloud native applications.

The main gap to close is related to the total cost of ownership (TCO) of Cloud RAN products that have over-dimensioned and static hardware footprint which is proposed to be avoided due to the easy deployment configuration for specific infrastructure characteristics and runtime scaling of applications relying on EM.

It is expected that an EM can be supported in the computing environment, e.g., in a cloud computing environment. However, one of the issues with the traditional deployment approach for EM is the tight coupling of EOs with underlying EM resources requiring specific configuration considering hardware characteristics to be defined for each application. This constraint prevents any possible adaptation to different deployment contexts, and each EM deployment case needs to be worked specifically. In addition, the initial configuration is applied during the whole lifetime of a deployed EM and any configuration update requires deploying the EM again and results in a service interruption.

The low latency communication and local data sharing require that EOs of some applications run on the same host. However, depending on the capacity planned for the given deployment, the respective dimensioning of the applications can change from one deployment to another.

Furthermore, in the use cases of 5G RAN, the introduction of guaranteed resources for specific types of network slices available on-demand can be ensured with the currently used static configuration only if those resources are permanently reserved regardless they are used or not at a given point of time. Sharing of EM resources and configuring them on-the-fly when a given application type is requested or higher processing load is required would allow to serve RAN slices efficiently. With the 5G context described above and the increasing requirement for dynamicity, there is emerging need for decoupling the acceleration service (e.g., EM) from the functional components (e.g., EOs).

As the EOs of the application are tightly coupled with the EM and deployed in the same container, traditionally, the design of which EO uses which EQ is done prior to the deployment and tailored to the hardware capacity. It is also statically configured as well which EQ belongs to which EQG, since the requirements of the application that is going to use the given EM are known in advance.

Different platform characteristics at least require customizing the core affinity setting in EQGs, the number of EQs per EQG and the mapping of EOs to those EQs and create a new container image that includes the EO libraries and the EM library with the specific parameters coupling them. This container image is then used to deploy the application in the network function and cannot be changed during runtime. As in typical RAN applications, different levels of user plane functions scale differently, adding more instances of the statically configured application or EOs would be also highly inefficient.

### Work Principle and Example Architecture

According to example embodiments of the present disclosure, there is proposed a solution for optimized deployment of an acceleration service associated with functional components in a computing environment. In this solution, a service instance for an acceleration service is deployed in a container in a computing environment based on configuration information related to the acceleration service. The service instance is a virtualized framework for the acceleration service. Depending on deployment demands, one or more functional components are deployed in the service instance as functional component instances. A part of resources of the container is mapped to a deployed functional component instance for use based on a resource requirement of the corresponding functional component. Then data related to the functional component instance is processed by the service instance using the part of mapped resources.

In some example embodiments, the functional component instances deployed in the service instance may be scaled or removed, and one or more new or different functional component instances may be deployed in the service instance or a new service instance for the acceleration service.

Through the solution, functional components of the application(s) can be flexibly and dynamically deployed, scaled, or removed on demand during runtime. There is still fast delivery between the functional component instances and the service instance within the same container, for example, through IPC, and thus it is still possible to achieve the acceleration target.

Example embodiments of the present disclosure will be described in the following. In some of the following embodiments, EM is described and illustrated as an example of an acceleration service. It should be appreciated that the solution described in the example embodiments of the present disclosure can be applied to other types of acceleration service.

In some example embodiments, an acceleration service may include a software enabler for applications, such as the Data Plane Development Kit (DPDK). DPDK is the Data Plane Development Kit that consists of libraries to accelerate packet processing workloads running on a wide variety of CPU architectures. DPDK can greatly boosts packet processing performance and throughput, allowing more time for data plane applications. Other software enabler may include enabler for user-space processing, vector processing/parallelization libraries, neural network computing acceleration libraries, protocol specific packet processing. In such examples, the functional components associated with the acceleration service may be adapted to run on top of the specific libraries deployed and controlled via the framework described in the invention.

In some example embodiments, an acceleration service may include a hardware accelerator, such as a System-On-Chip accelerator. In such examples, the functional components may include Digital Signal Processing (DSP) functions configured for the hardware accelerator. In other example embodiments, any other acceleration services that need fast delivery between corresponding processes invoked in runtime may also be adapted and benefited from the solution of the present disclosure.

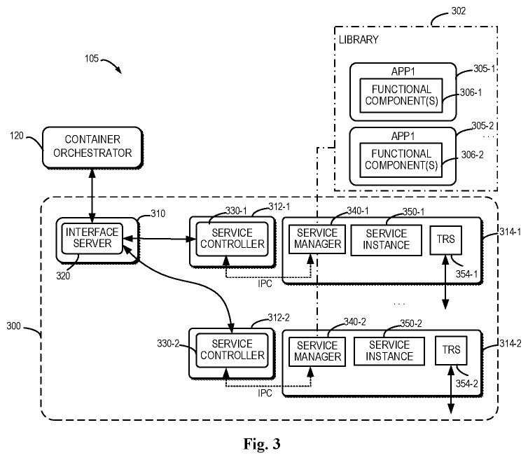

Reference is made to FIG. 3, which shows example architecture 300 for service deployment in a computing environment according to some example embodiments of the present disclosure. For the purpose of discussion, the architecture 300 is implemented within the computing environment 105 of FIG. 1.

As illustrated in FIG. 3, the architecture 300 includes entities to implement the flexible deployment of functional components associated with one or more acceleration services. It should be appreciated that the number of some entities in FIG. 3 is illustrated as an example and any other number may also be possible.

In the architecture 300, one or more service instances, such as service instances 350-1, 350-2 are deployed in containers 314-1, 314-2, respectively. The service instances 350-1, 350-2 may be instances of a same acceleration service or different acceleration services. For the purpose of discussion, the service instances 350-1, 350-2 are collectively or individually referred to as service instances 350, and the containers 314-1, 314-2 are collectively or individually referred to as containers 314. As will be discussed in detail below, the service instances 350 may be deployed dynamically and may be scaled or removed on-demand.

One or more functional components of an application are configured to be associated with an acceleration service. With a service instance 350 deployed, one or more associated functional components of the application may be dynamically deployed in the associated service instance 350 as functional component instances. In FIG. 3, an application 305-1 (APP1) with one or more functional components 306-1 and an application 305-2 (APP2) with one or more functional components 306-2 are included in a library 302. For the purpose of discussion, the applications 305-1, 350-2 are collectively or individually referred to as applications 305, and the functional components 306-1, 306-2 are collectively or individually referred to as functional components 306. As will be discussed in detail below, corresponding functional component instances of the individual functional components 306 may be dynamically deployed and may be scaled or removed on-demand.

In some example embodiments, an acceleration service comprises an EM, and a corresponding service instance 350 deployed in the container 314 may be referred to as an EM instance. In such embodiments, the functional components 306 may include one or more EOs of one or more applications associated with the EM. With the characteristics of dynamic deployment and scaling, the EM is considered as an EM as a service (EMaaS) in the example embodiments of the present disclosure.

To manage and maintain the service instances of acceleration services and the associated functional components of the applications, the architecture 300 may comprise service manager instances 340-1, 340-2 (collectively or individually referred to as service managers 340) deployed in the respective containers 314-1, 314-2. A service manager instance 340 is associated with a service instance 350 and may be deployed in the same container 314 with the service instance 350. A service manager instance 340 is an instance of a service manager configured to initialize an associated service instance 350 and perform the deployment of associated functional components 306 in the associated service instance 350. The service manager instance 340 may also be configured to translate a resource requirement of a functional component into allocation and assignment of physical resources (e.g., CPUs, cores, memories, and I/O) of a container 314. As such, depending on the resource requirement of the functional component, at least a part of resources of the container 314 can be mapped to the functional component instance deployed in the service instance 350.

The architecture 300 may also comprise one or more service controller instances 330-1, 330-2 (collectively or individually referred to as service controller instances 330) deployed in respective containers 312-1, 312-2 (collectively or individually referred to as containers 312). A service controller instance 330 is an instance of a service controller which is configured to handle lifecycle management (LCM) actions on the functional component instances deployed in the service instance 350 and defines required configuration instructions to be issued to the service manager instance 340. The LCM actions may include deployment, scaling in or out, removing of the functional component instances of the functional components 306 and the associated service instances 350. The configuration instructions may be determined, for example, based on information about current operating states of functional component instances and user desired states of the functional component instances.

A service controller instance 330 may be associated with at least one service instance 350. In FIG. 3, a service controller instance 330 is illustrated to be associated with one service instance 350 in the container 314. In other examples, a service controller instance 330 may be associated with more than one service instance 350 and configured to handle LCM actions on the functional component instances and the associated service instances 350.

In some example embodiments, the service controller instance 330 may communicate with a service manager instance 340 deployed for the associated service instance 350, to instruct the service manager instance 340 to perform certain actions (deployment, scaling in or out, removing or other LCM actions) on functional component instances in the associated service instance 350.

In some example embodiments, the service controller instance 330 may have IPC communications with the service manager instance 340 in order to support communication related to service instance configuration or other purpose. In some examples, when deploying a new service instance, a transport (TRS) module may also be deployed in the container 314 to support network I/O access between the service instance 350 and external network entities. As illustrated in FIG. 3, a TRS module 354-1 is deployed in the container 314-1 for the service instance 350-1, and a TRS module 354-2 is deployed in the container 314-2 for the service instance 350-2. The TRS modules 354-1 354-2 are collectively or individually referred to as TRS modules 354.

The architecture 300 may further comprise an interface server 320 which is configured to interface with the container orchestrator 120 in the computing environment 105 and with the service controller instances 320. The interface server 320 may be deployed as an instance in a container 310. In some example embodiments, the interface server 320 may be a central component in the architecture 300. Alternatively, two or more instances of the interface server may be deployed in respective containers in the architecture 300, with each instance interfacing with at least one service controller instance 330.

The interface server 320 may be configured to determine LCM decisions on whether to deploy, scale in or out, remove, or apply other LCM actions on the service instances 350 and the associated functional component instances deployed therein. In some example embodiments, the interface server 320 may monitor status of the service instances 350 and collect metrics useful in making the LCM decisions. The metrics may include volumes of workload, performance metrics (PMs) and so on.

In some example embodiments, the interface server 320 may be configured to keep track of resource availability per service instance and dynamically determine whether a new service instance or functional component instance is deployed, or whether a deployed service instance or functional component instance is to be scaled or removed. In some example embodiments, the interface server 320 may collect the metrics (such as volumes of workload) per service instance, per application, and/or per functional component deployed. In some cases, the interface server 320 may receive the metric from a monitoring plugin such as Prometheus.

In some example embodiments, the service instances 350 may expose the collected metrics to an external entity, such as the container orchestrator 120 or other external management system to make the LCM decisions for the service instances 350.

In some example embodiments, the container orchestrator 120 is configured to orchestrate containers in the architecture 300, for example, to determine whether to deploy a new container, to scale or remove a deployed container, and the like. The interface server 320 may communicate with the container orchestrator 120, to receive the container-level orchestration decision from the container orchestrator 120 and perform the decision accordingly in conjunction with the service controller instance 330.

In some example embodiments, the containers in the computing environment 105 may include Kubernetes containers or other containerization platforms. In some example embodiments, the containers in the computing environment 105 may run on bare-metals and not compatible with Kubernetes.

Some example of general procedures between the entities in the architecture 300 will be described in the following.

In a procedure for deploying a new application 305 associated with an acceleration server, the interface server 320 may receive, e.g., from the container orchestrator 120, a request for operating the new application 305. In some example embodiments, if no service instance is deployed for the acceleration service, the container orchestrator 120 may deploy a new service instance 350 of the acceleration service. The service instance 350 may be deployed in a container 314 based on configuration information related to the acceleration service. In some example embodiments, a service controller instance 330 that has been deployed may be configured as being associated with the newly deployed service instance 350. In some example embodiments, the container orchestrator 120 may deploy a new service controller instance 330 in a container 310 for the service instance 350.

In some example embodiments, deploying a new service instance of the acceleration service may include deploying a service manager instance 340 in the container 314, and deploying basic elements of the acceleration service based on the configuration information. For example, for an EM instance, a scheduler and a dispatcher may be initialized in the container 314. The interface server 320 may receive the configuration information from the container orchestrator 120 or other scheduler in the computing environment 105. In some examples, a TRS module 354 may also be deployed in the container 314 for the new deployed service instance 350.

With the service instance 350 deployed, the service controller instance 330 is instructed by the interface server 320 to prepare configuration for deploying the functional components of the application 305 in the deployed service instance 350. The service controller instance 330 may send a request to the service manager instance 340. The service manager instance 340 may translate the request for the service instance 350 into specific parameters to create the functional component instances in the service instance 350.

In some example embodiments, if one or more service instances 350 of the acceleration service have been deployed, the interface server 320, upon receiving the request for deploying the new application 305, may request the service controller 330 to determine whether an appropriate deployed service instance 350 can be selected for the application. The selection may be, for example, based on volumes of workload in the deployed service instances 350, operating states of the deployed service instances 350, and/or deployment preference information of the application 305. If a deployed service instance 350 is selected, one or more functional component instances of the corresponding functional components 306 of the application 305 may be deployed within the deployed service instance 350.

In some example embodiments, if one or more functional component instances of functional components have been deployed for one or more applications 305, it is allowed to scale out the functional components 306 or the applications 305. In a procedure for scaling out a specific functional component 306 or a specific application 305, the interface server 320 may be triggered to perform the scaling out by deploying the functional component instance(s) into a new service instance of the same acceleration service in the granularity of the functional components or the application 305. Alternatively, the interface server 320 may be triggered to allocate more resources for the service instance 350 such that the resources mapped to the corresponding deployed functional component instance or the deployed functional component instances for the specific application 305 can be increased. In some example embodiment, the service controller instance 340 and the service manager instance 350 may execute corresponding actions to perform the scaling out.

In some example embodiments, it is also allowed to scale in or remove one or more deployed functional component instances. The scaling in or removal may be performed at a functional component level or at an application level. In a procedure for scaling in or removing a specific functional component or an application, the interface server 320 may also be triggered to initiate the scaling in or removal. In some examples, the scaling in may include reduce the resource amount mapped to a functional component instance. In some examples, if more than one instance of a specific functional component is deployed more than one service instance, the interface server 320 may determine to remove some of those instances to achieve the purpose of scaling out. In the case of removing, the deployed instances for the specific functional component or for the functional components of the application may be deleted from the corresponding service instance 350. In some example embodiment, the service controller instance 340 and the service manager instance 350 may execute the corresponding actions to perform the scaling in or removing.

In some example embodiments, the interface server 320 may also be triggered to scale in or scale out an acceleration service, for example, by deploying additional service instance(s) or removing one or more deployed service instances 350. In some cases, all the deployed service instances 350 of an acceleration service may be removed from the computing environment, in order to remove the acceleration service that is determined to be not used.

In some example embodiments, the interface server 320 or the container orchestrator 120 may determine whether to scale a specific functional component, functional components of a specific application, or an acceleration service, for example, depending on whether the volume of workload in the deployed instance at the corresponding level (functional component, application, or service) is above or below a predetermined threshold. In some example embodiments, the interface server 320 may determine whether to scale functional components of a specific application or a specific functional component.

In some example embodiments, although not shown, service instances of two or more different acceleration services may be deployed in the architecture 300 and the functional component instances may be dynamically deployed and scaled in a similar way.

In some example embodiments, two or more service instances of a same acceleration service may be deployed for the same application 305 or for different applications 305 in the architecture 300.

As the infrastructure resources are only created and allocated to the container via software deployment and does not require any specific hardware capabilities, the resource management can be handled within the Cloud native Network Function (CNF) in the computing environment. Once the new service instance 350 is deployed in the container 314, the underlying resources of the container 314 are available for functional components 306 of the application(s) 305. The basic elements (e.g., scheduler or dispatcher) of the acceleration service and the functional component instances may then be deployed to consume the resources. At this point of view, the basic elements of the acceleration service and the functional component instances may be different from the logic application container and can be considered as part of a Platform as a Service (PaaS) layer.

According to the example embodiments of the present disclosure, by introducing service instances and flexible deployment of functional components (e.g., EMaaS) of the applications, the service instance is considered as a generic service platform integrated with real-time functional components of the applications. The service instance may be delivered together with the functional components in the same container becomes a service platform shared by the functional components that are deployed therein. A functional component may require the availability of a specific amount of resources in the container to trigger its deployment or scaling dynamically. In addition, resources of a container can be shared under a single service instance, increasing resource pooling efficiency and simplifying fast path communication between functional components deployed on the same service instance.

### Example Configuration for Acceleration Service

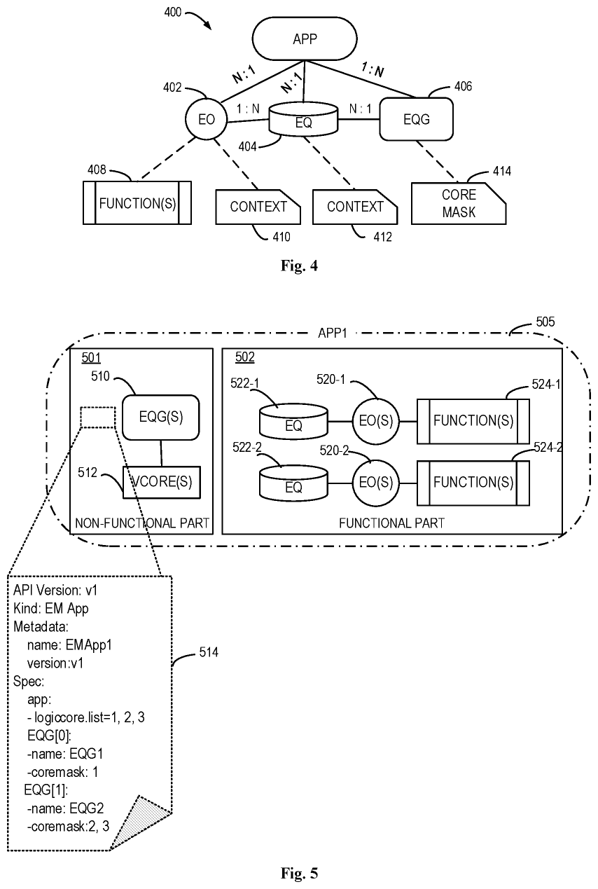

To deploy functional components of applications into the service instance dynamically and flexibly, characteristics or requirements for functional components of an application may be dynamically determined. As an example, FIG. 4 illustrates an example structure 400 of some elements of an application associated with an EM according to some example embodiments of the present disclosure. As illustrated, an application may be associated with one or more EOs 402 (1:N), an EO 402 may be associated with one or more EQs 404 (1:N) into which events related to the EO 402 may be placed; and one or more EQs 404 may be grouped into an EQG 406 (N:1). Thus, the application is considered to be associated with one or more EQs 404 (1:N) and may be associated with one or more EQGs 406 (1:N). It is noted that among the indicated association relationships (1:N), N may be the same or different for each pair of element in FIG. 4.

An EO 402 may have one or more functions 408 for execution and has related contextual information 410. An EQ 404 also has related contextual information 412. An EQG 406 may have a core mask 414 to indicate to which cores(s) the EQG is mapped.

The events in the EQG 406 may be scheduled to the mapped core for processing. For example, if there are total four cores required for the application, the four cores may be indexed, for example, from 1 to 4. The core mask 414 of an EQG 406 indicates, through the indexes, that one or more of the four cores are mapped to the EQG 406.

FIG. 5 illustrates an example of deconstruction of an application 505 and a specification for the application 505 associated with an EM according to some example embodiments of the present disclosure. An application 505 for an EM may be deconstructed into a non-functional part 501 and a functional part 502. The non-functional part 501 may indicate how to run the application 505 and may indicate the elements of the application such as one or more EQGs 510 and one or more virtual cores (vCores) 512. The non-functional part 501 may further include an application specification 514 indicating how to run the application, which may at least indicate the association relationship between the EQGs 510 and the virtual cores 512. A specific example of the application specification 514 is illustrated in FIG. 5. The application specification 514 may be customized or configured for different applications in different use cases.

The functional part 502 may indicate what to run for the application 505. As illustrated, the functional part 502 may include one or more EOs 520-1 and 520-2, one or more EQs 522-1, 522-2 to which the EOs 520-1 and 520-2 are mapped, and one or more functions 524-1 and 524-2 for the EOs 520-1 and 520-2 respectively. It is noted that the number of those elements illustrated here is merely used as an example.

By formalizing the elements including the functional components of an application for EM, it enables flexible and dynamic configuration of EM resources used by the application. This also enables application adaptability to platform and capacity requirements of a given deployment and modification of the application deployment during runtime by scaling in or out specific EOs independently from each other and from the EM instance.

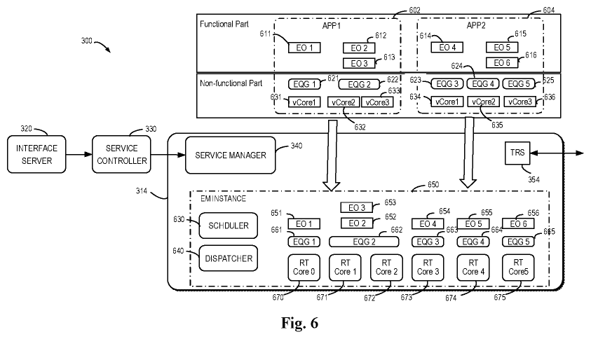

Depending on the deconstruction of the application associated with an EM, an example deployment of the EM and EOs in the example architecture 300 are illustrated in FIG. 6. In this example, an EM instance 650 for an EM is deployed in a container 314, and applications 602 and 604 with multiple EOs are to be deployed. For a new deployment of an application 602 or 604, the interface server 320 may determine an EM instance to deploy the EOs of the application. If no such an EM instance is initiated, the interface server 320 may request to the container orchestrator 120 to deploy a container and an EM instance in the container. The associated service controller instance 330, the service manager instance 340 and optionally the TRS module 354 may also be deployed if not available. To deploy an EM instance, a scheduler 630 and a dispatcher 640 may be initiated within the EM instance. The scheduler 630 and the dispatcher 640 may operate in a similar way as in the conventional EM framework. In addition, the deployment of the EM instance 650 may also allow some physical resources of the container to be available for the EM instance 650. For example, in FIG. 6, cores for use by the dispatcher 640, e.g., RT Core0 670 to RT Core5 675 are allocated for the EM instance 650.

If the EM instance 650 is deployed in the container 314, the interface server 320 may request to the service controller instance 330 and the service controller instance 330 may request to the service manager instance 340 to deploy one or more EOs of the applications 602 and/or 604.

The service manager instance 340 may receive, from the service controller instance 330, the request to deploy the EO instances and may translate the request to the EM instance specific configuration parameters so as to create new EOs, EQs (not specifically shown in FIG. 6), EQGs, and related resources for the EOs.

As illustrated, EO1 to EO3 611 to 613 of the application 602 are determined to be deployed to the EM instance 650 as EO instances 651 to 653, and EQG1 661 and EQG2 662 are also initiated in the EM instance 650 depending on the configuration of the non-functional part of the application 602. Depending on the resource requirements of the EOs, resources may be allocated for the deployed EO instances. In particular, the service manager instance 340 may be configured to map, according to the application specification of the application 602, the required virtual cores to RT cores that are allocated for the dispatcher 640 in the EM instance 650. As illustrated, the EQG1 661 is mapped to the RT Core0 670, and the EQG2 662 is mapped to the RT Corel 671 and RT Core2 672.

Similarly, EO4 to EO6 614 to 616 of the application 604 may also be deployed to the EM instance 650 as EO instances 654 to 656, and EQG3 663 to EQG5 665 are initiated for those EOs. According to the application specification of the application 604, the EQG3 663 is mapped to the RT Core3 673, the EQG4 664 is mapped to the RT Corel 674, and the EQG5 665 is mapped to the RT Core5 675.

Although a one-to-one mapping between the virtual cores and the RT cores is illustrated, in other examples, the virtual cores specified by different applications may be mapped to the same RT core due to the virtualization techniques in the computing environment.

It should be appreciated that the example of FIG. 6 is provided as an example only and other deployments may also be possible for an EM and applications required the accelerations provided by the EM.

### Example Implementation of Entities

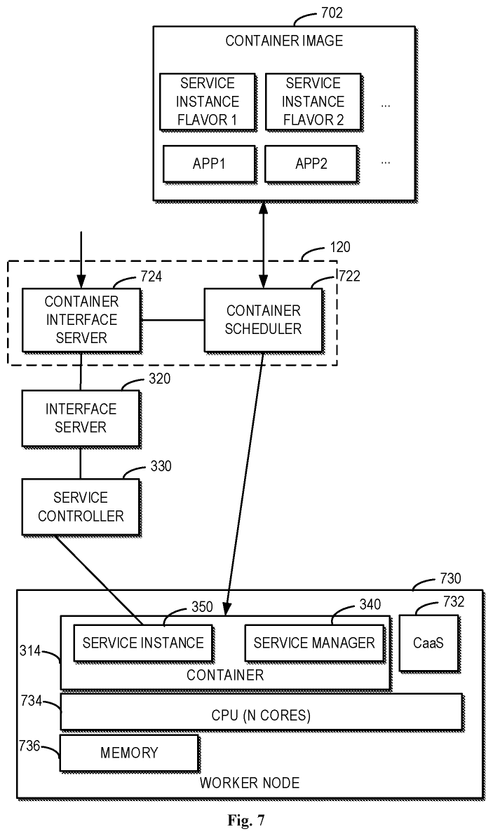

FIG. 7 illustrates an example of implementing the service instance in a physical worker node according to some example embodiments of the present disclosure. As illustrated, a container 314 with the service instance 350 and the service manager instance 340 deployed therein may be implemented in a worker node 730. The worker node 730 is virtualized in the computing environment 130 with a Container as a Service (CaaS) module 732. The physical resources of the worker node 730, such as a CPU 734 with one or more cores (n cores) and a memory 736 may be allocated for the operation of the service manager instance 340 and the service instance 350.

In the example of FIG. 7, the container orchestrator 120 includes a container scheduler 722 and a container interface server 724. During operation, the container scheduler 722 may schedule a container 314 to be deployed based on a container image 702, which may specify one or more applications allowed to be deployed in a service instance in the container 314. The applications may be configured with one or more functional components and possible other elements that support the execution of the functional components, such as the example configuration in FIG. 5. In some cases, the container image 702 may further specify one or more service instance flavors for the applications, which may indicate the preference information of the application when their functional components are deployed into a service instance. The container interface server 724 may be interfaced with the interface server 320, to communicate information and requests with the interface server 320.

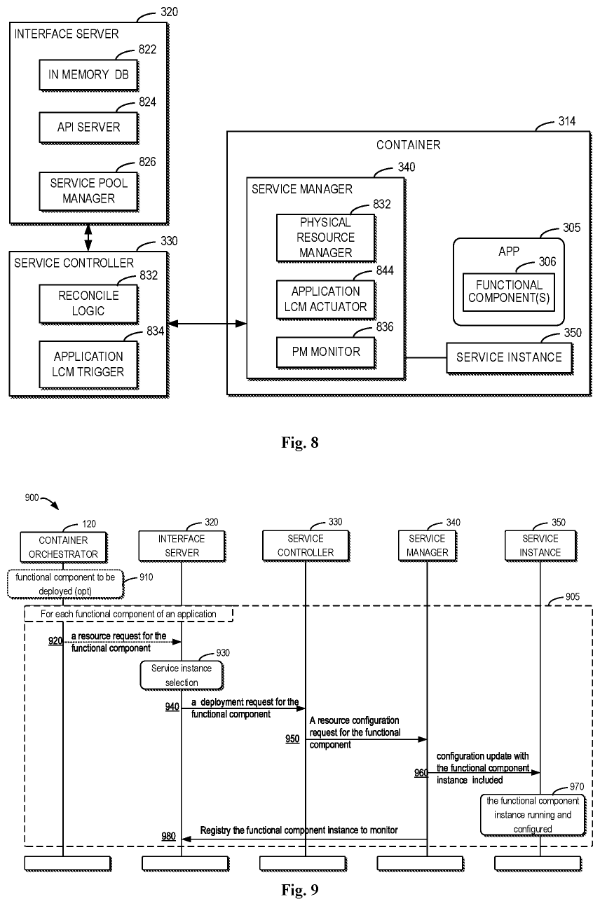

FIG. 8 illustrates an example of logic implementations of entities in the architecture 300 according to some example embodiments of the present disclosure. As illustrated, the interface server 320 includes an in-memory database (DB) 822 to store configuration information related to acceleration services, application specifications and configuration of applications with functional components, and possible some metrics related to the deployed instances. The in-memory DB 822 may be co-located with other logic components of the interface server 320 in the same container 310 or may be located in other containers for a distributed deployment.

The interface server 320 also includes an application programming interface (API) server 824 to communicate with the external container orchestrator 120 and with the deployed service controller instance(s) 330. The interface server 320 further includes a service pool manager 826 to manage service instances 340. In the architecture 300, a plurality of service instances 340 may be managed as a pool. The API server 824 may collect information related to the workload of the EM instances and performance metrics. The service pool manager 826 may determine the deployment, scaling, or removing of the application (or specific functional components) based on requests from external entities or based on its LCM decisions.

The service controller instance 330 includes reconcile logic 832 to read inputs from the API server 824 and inputs from the service manager instance 340. The service controller instance 330 includes an application LCM trigger 834 to manage LCM actions related to the service instance 350, the application 305 or the specific functional components 306 of the application. The application LCM trigger 834 may trigger the service manager instance 340 to execute actions. In some examples, the application LCM trigger 834 may be configured to perform some extra configurations when necessary, such as for I/O related configuration.

The service manager instance 340 includes a physical resource manager 832 to manage the physical resources allocated to the container 314 and to map the resource required by the functional components 306 to the corresponding functional component instances deployed in the service instance 350. The service manager instance 340 also includes an application LCM actuator 844 configured to actuate the LCM actions requested by the service controller instance 330 and a PM monitor 836 to monitor performance metrics of the functional component instances deployed in the service instance 350.

### Example Signaling Flows Between Entities

The operations of the components in the architecture 300 have been discussed in the example embodiments above. Some example signaling flows between the entities in the architecture 300 in the use cases of deploying, scaling out, scaling in one or more functional component instances or an acceleration service, and removing one or more functional component instances or a service instance.

FIG. 9 illustrates a signaling flow 900 of deploying or scaling out a functional component according to some example embodiments of the present disclosure.

In some cases, a new application or a new functional component of an application may be added to a service instance for a newly deployed application service. In some example embodiments, the trigger of the addition is the deployment of an application specification of a customer resource type in the Kubernetes. In some example embodiments, it may be triggered by the container orchestrator 120 which determines to deploy a new container in the computing environment. In some example embodiments, the interface server 320 may determine to add a new application or a new functional component of an application.

In some cases, if a functional component has been deployed with an instance (i.e., a functional component instance), the interface server 320 may determine to scale out the functional component, for example, by deploying one or more additional functional component instances in the same or different containers 314.

In the signaling flow 900, as some optional steps, the container orchestrator 120 triggers 910 one or more functional components to be deployed and transmits 920 a resource request for the functional components. For each of the functional components, the entities may perform a procedure 905. It is noted that 910 and 920 are optional steps.

The interface server 320 determines 930 a service instance selection for a functional component to be deployed and transmits 940 a deployment request for the functional component to the service controller instance 330. The interface server 320 may determine whether to initiate a new service instance of an acceleration service first or deploy the functional component as an instance in a deployed service instance.

Upon receipt of the deployment request, the service controller instance 330 determines and transmits 950, to the service manager instance 340, a resource configuration request for the functional component. The resource configuration request may indicate the resource of the container 314 is configured or mapped to a new functional component instance for the current functional component. The service manager instance 340 performs the deployment of the corresponding functional component instance in the service instance 350. Specifically, the service manager instance 340 determines and provides 960, to the service instance 350 a configuration update of the service instance 350 with the functional component included therein as an instance (i.e., to deploy the functional component instance within the service instance 350).

With the configuration update, the functional component instance is configured and run 970 within the service instance 350. The data related to the functional component instance may be provided to the service instance 350 to process.

In some example embodiments, the interface server 320 may registry 980 with the interface server 320 the functional component instance to monitor. As such, the interface server 320 may be able to monitor the performance metrics, the volume of workload related to the newly deployed functional component instance.

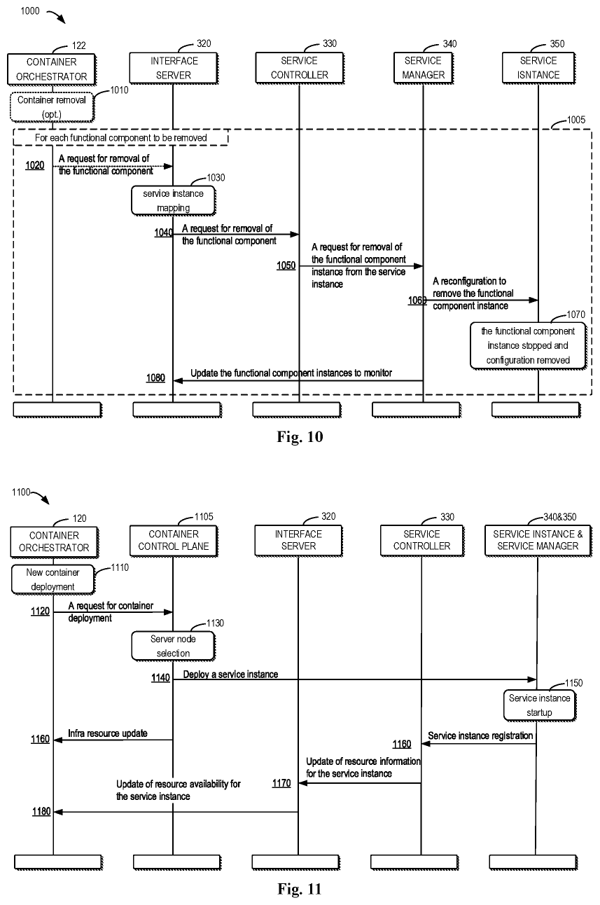

FIG. 10 illustrates a signaling flow 1000 of removing or scaling in a functional component according to some example embodiments of the present disclosure. As mentioned above, the interface server 320 may trigger scaling in of one or more specific functional components or an application (which may results in scaling in the associated functional components) or the removal of the functional component instance. In some cases, the container orchestrator 122 may trigger a removal of a container, which may lead to removal of the functional component instances deployed therein.

In the signaling flow 1000, as some optional steps, the container orchestrator 120 triggers 1010 a container removal and transmits 1020 a request for removal of the functional components. For each of the functional components to be removed, the entities may perform a procedure 1005. It is noted that 1010 and 1020 are optional steps.

The interface server 320 determines 1030 a service instance mapped to the functional component to be removed and transmits 1040 a request for removal of the functional component to the service controller instance 330. Upon receipt of the request, the service controller instance 330 determines and transmits 1050, to the service manager instance 340, a request for removal of the functional component instance from the mapped service instance. The request may cause the reconfiguration of resources of the service instance 350. The service manager instance 340 performs the resource configuration and provides 1060, to the service instance 350 a reconfiguration to remove the functional component instance from the service instance 350.

With the reconfiguration, the functional component instance is stopped and the configuration related to the functional component instance is removed 1070 from the service instance 350. In some example embodiments, the interface server 320 may update 1080 with the interface server 320 the functional component instances to monitor, by notifying it to stop monitoring the removed functional component instance.

FIG. 11 illustrates a signaling flow 1100 of deploying in a service instance of an acceleration service according to some example embodiments of the present disclosure. In such embodiments, an acceleration service may be dynamically deployed as one or more service instances. This capability brings additional benefits especially for deployments in larger datacenters with multi-tenancy and can adaptation to the varied requirements for the acceleration service.

In the signaling 1100, the container orchestrator 120 determines 1110 new container deployment and transmits 1120 a request for the container deployment. A container control plane 1105, which is configured for implementing the container deployment, performs a server node selection 1130, to determine a server node for deploying the container. The container control plane 1105 deploys 1140 a service instance as a service instance 350 of an acceleration service together with the container to be deployed. In addition, a service manager instance 340 and other elements in the container for supporting the service instance may also be initialized. When the container is deployed, the service instance 350 is set up 1150 in the container. The service manager instance 340 may request 1160 the service controller instance 330 to register the service instance.

The service controller instance 330 may record that the new service instance 350 is deployed and update 1170 the resource information for the service instance. The service manager instance 340 may further update 1180 the resource availability for the service instance with the container orchestrator 120.

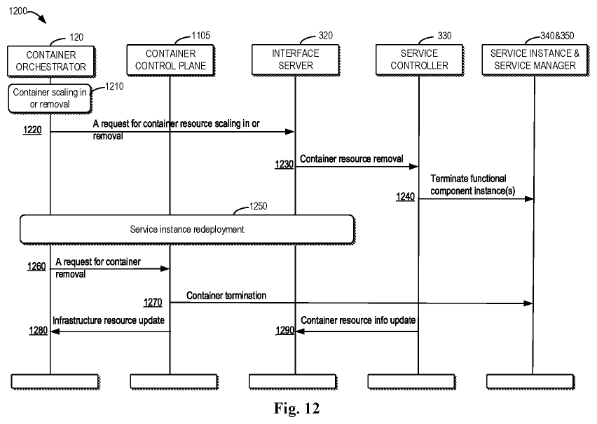

FIG. 12 illustrates a signaling flow 1200 of removing or scaling in a service instance of an acceleration service according to some example embodiments of the present disclosure.

When some of the service instances are constantly not used, the interface server 320 may be able to detect it and request from the container orchestrator 120 to remove the related container 314 so that the reserved resources can be released and can be used for the deployment of other instances. In some cases, a container 314 may be scaled in, for example, by reducing the allocated resources. In such cases, the functional component instances deployed in the container 314 may be terminated in order to release the resources.

In the signaling flow 1200, the container orchestrator 120 determines 1210 that a container needs to be scaled in or removed and transmits 1220 a request for container resource scaling in or removal. The interface server 320 may determine the container resource to be removed for the purpose of scaling in or container removal and informs the service controller instance 330 the container resource removed. The service controller instance 330 may determine 1240 to terminate some or all of the functional component instances deployed in the container with the service instance.

In such a case, a new service instance of the same acceleration service may be redeployed 1250 for deploying the terminated functional component instance(s). The redeployment may involve the container orchestrator 120, the container controller plane 1105, the interface server 320 and other service controller instance. Then in the case of container removal, the container orchestrator 120 transmits 1260 a request for container removal to the container controller plane 1105. The container controller plane 1105 may perform 1270 the termination of the container. In either case of scaling in or removal, the service controller instance 330 may provide 1290 the container resource information update to the interface server 320 and the container controller plane 1105 may provide 1280 the infrastructure resource update to the container orchestrator 120.

### Example Process

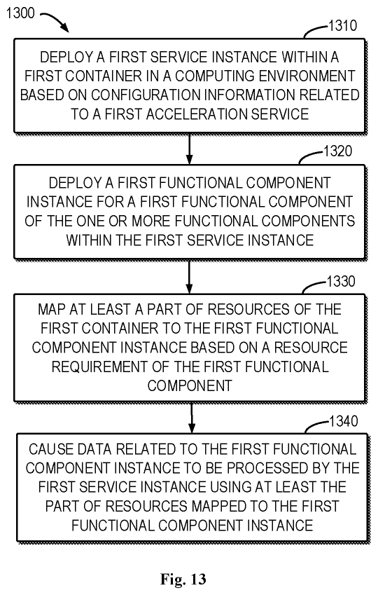

FIG. 13 shows a flowchart of an example method 1300 in accordance with some example embodiments of the present disclosure. For the purpose of discussion, the method 1300 will be implemented in the computing environment 105, especially the architecture 300 as illustrated in FIG. 3.

At block 1310, a first service instance is deployed within a first container in a computing environment based on configuration information related to a first acceleration service, the first acceleration service to be associated with one or more functional components. At block 1320, a first functional component instance for a first functional component of the one or more functional components is deployed within the first service instance. At block 1330, at least a part of resources of the first container is mapped to the first functional component instance based on a resource requirement of the first functional component. At block 1340, data related to the first functional component instance are to be processed by the first service instance using at least the part of resources mapped to the first functional component instance.

In some example embodiments, the first acceleration service comprises an event machine, wherein the one or more functional components comprise a plurality of execution objects, and the data comprises at least one event.

In some example embodiments, the method 1300 further comprises: receiving a request for operating a second functional component of the one or more functional components; and in response to the request, deploying a second functional component instance for the second functional component within the first service instance.

In some example embodiments, the method 1300 further comprises: in accordance with a determination of scaling out of the first functional component, performing at least one of the following: mapping an additional part of resources to the first functional component instance based on the resource requirement, and deploying a further functional component instance for the first functional component within a second service instance, the second service instance being deployed in a second container based on the configuration information related to the first acceleration service.

In some example embodiments, the method 1300 further comprises: in accordance with a determination of removal of the first functional component instance, removing the first functional component instance from the first container.

In some example embodiments, the method 1300 further comprises: in accordance with a determination of scaling out of the first acceleration service, deploying a further service instance within a third container based on the configuration information related to the first acceleration service.

In some example embodiments, the method 1300 further comprises: in accordance with a determination of removal of the first service instance, removing the first functional component instance from the first container, and removing the first service instance.

In some example embodiments, the method 1300 further comprises: deploying an interface server in a fourth container in the computing environment, the interface server being configured with an interface with a container orchestrator of the computing environment; and determining, with the interface server, at least one of the following: the deployment of at least one of the first service instance and the first functional component instance, removal of at least one of the first service instance and the first functional component instance, and scaling of at least one of the first acceleration service and the first functional component.

In some example embodiments, the method 1300 further comprises: monitoring a volume of a workload of the first functional component instance; and wherein at least one of the removal and the scaling is determined at least based on the volume of the workload.

In some example embodiments, determining the deployment of the first service instance comprises: receiving, with the interface server, a request for operating the first functional component; and in response to the request, determining to deploy the first service instance.

In some example embodiments, the method 1300 further comprises: deploying a service controller instance in a third container in the computing environment, the service controller instance being associated with at least the first service instance; in accordance with the determination of the at least one of the deployment of the first service instance, the removal of the first service instance, and the scaling of the first acceleration service, causing a first instruction to be communicated from the interface server to the service controller instance; and in response to the first instruction, performing, with the service controller instance, the at least one of the deployment, the removal, and the scaling in the computing environment.

In some example embodiments, the method 1300 further comprises: deploying a service controller instance in a third container and a service manager instance in the first container, the service controller instance being associated with at least the first service instance; in accordance with the determination of the at least one of the deployment of the first functional component instance, the removal of the first functional component instance, and the scaling of the first functional component, causing a second instruction to be communicated from the service controller instance to the service manager instance; and in response to the second instruction, performing, with the service manager instance, the at least one of the deployment, the removal, and the scaling in the first container.

In some example embodiments, a first apparatus capable of performing any of the method 1300 (for example, the entities in the architecture 300) may comprise means for performing the respective operations of the method 1300. The means may be implemented in any suitable form. For example, the means may be implemented in a circuitry or software module. The first apparatus may be implemented as or included in the architecture 300.

In some example embodiments, the first apparatus comprises means for deploying a first service instance within a first container in a computing environment based on configuration information related to a first acceleration service, the first acceleration service to be associated with one or more functional components; deploying a first functional component instance for a first functional component of the one or more functional components within the first service instance; mapping at least a part of resources of the first container to the first functional component instance based on a resource requirement of the first functional component; and causing data related to the first functional component instance to be processed by the first service instance using at least the part of resources mapped to the first functional component instance.

In some example embodiments, the first acceleration service comprises an event machine, wherein the one or more functional components comprise a plurality of execution objects, and the data comprises at least one event.

In some example embodiments, the apparatus further comprises means for: receiving a request for operating a second functional component of the one or more functional components; and in response to the request, deploying a second functional component instance for the second functional component within the first service instance.

In some example embodiments, the apparatus further comprises means for: in accordance with a determination of scaling out of the first functional component, performing at least one of the following: mapping an additional part of resources to the first functional component instance based on the resource requirement, and deploying a further functional component instance for the first functional component within a second service instance, the second service instance being deployed in a second container based on the configuration information related to the first acceleration service.

In some example embodiments, the apparatus further comprises means for: in accordance with a determination of removal of the first functional component instance, removing the first functional component instance from the first container.

In some example embodiments, the apparatus further comprises means for: in accordance with a determination of scaling out of the first acceleration service, deploying a further service instance within a third container based on the configuration information related to the first acceleration service.

In some example embodiments, the apparatus further comprises means for: in accordance with a determination of removal of the first service instance, removing the first functional component instance from the first container, and removing the first service instance.

In some example embodiments, the apparatus further comprises means for: deploying an interface server in a fourth container in the computing environment, the interface server being configured with an interface with a container orchestrator of the computing environment; and determining, with the interface server, at least one of the following: the deployment of at least one of the first service instance and the first functional component instance, removal of at least one of the first service instance and the first functional component instance, and scaling of at least one of the first acceleration service and the first functional component.

In some example embodiments, the apparatus further comprises means for: monitoring a volume of a workload of the first functional component instance; and wherein at least one of the removal and the scaling is determined at least based on the volume of the workload.

In some example embodiments, the means for determining the deployment of the first service instance comprises means for: receiving, with the interface server, a request for operating the first functional component; and in response to the request, determining to deploy the first service instance.

In some example embodiments, the apparatus further comprises means for: deploying a service controller instance in a third container in the computing environment, the service controller instance being associated with at least the first service instance; in accordance with the determination of the at least one of the deployment of the first service instance, the removal of the first service instance, and the scaling of the first acceleration service, causing a first instruction to be communicated from the interface server to the service controller instance; and in response to the first instruction, performing, with the service controller instance, the at least one of the deployment, the removal, and the scaling in the computing environment.

In some example embodiments, the apparatus further comprises means for: deploying a service controller instance in a third container and a service manager instance in the first container, the service controller instance being associated with at least the first service instance; in accordance with the determination of the at least one of the deployment of the first functional component instance, the removal of the first functional component instance, and the scaling of the first functional component, causing a second instruction to be communicated from the service controller instance to the service manager instance; and in response to the second instruction, performing, with the service manager instance, the at least one of the deployment, the removal, and the scaling in the first container.

In some example embodiments, the apparatus further comprises means for performing other steps in some example embodiments of the method 1300. In some example embodiments, the means comprises at least one processor; and at least one memory including computer program code, the at least one memory and computer program code configured to, with the at least one processor, cause the performance of the apparatus.

### Example Device, Apparatus, and Medium

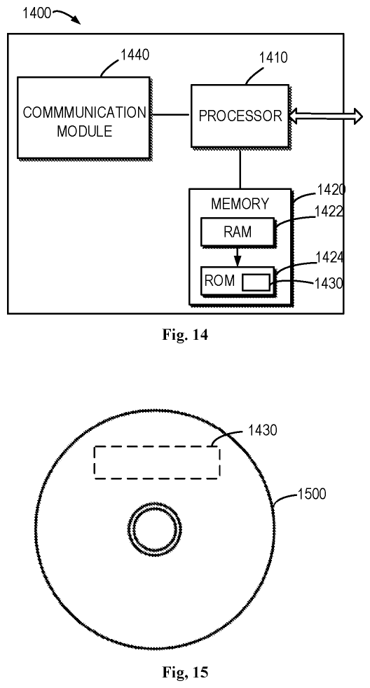

FIG. 14 is a simplified block diagram of a device 1400 that is suitable for implementing example embodiments of the present disclosure. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has one or more communication interfaces to facilitate communication with one or more other modules or devices. The communication interfaces may represent any interface that is necessary for communication with other network elements. In some example embodiments, the communication module 1440 may include at least one antenna.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1422 and other volatile memories that will not last in the power-down duration.

A computer program 1430 includes computer executable instructions that are executed by the associated processor 1410. The program 1430 may be stored in the memory, e.g., ROM 1424. The processor 1410 may perform any suitable actions and processing by loading the program 1430 into the RAM 1422.

The example embodiments of the present disclosure may be implemented by means of the program 1430 so that the device 1400 may perform any process of the disclosure as discussed with reference to FIGS. 3 to 13. The example embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. The computer readable medium may include any types of tangible non-volatile storage, such as ROM, EPROM, a flash memory, a hard disk, CD, DVD, and the like. FIG. 15 shows an example of the computer readable medium 1500 which may be in form of CD, DVD or other optical storage disk. The computer readable medium has the program 1430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIG. 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-26. (canceled)

27. A method comprising:
deploying a first service instance within a first container in a computing environment based on configuration information related to a first acceleration service, the first acceleration service to be associated with one or more functional components;
deploying a first functional component instance for a first functional component of the one or more functional components within the first service instance;
mapping at least a part of resources of the first container to the first functional component instance based on a resource requirement of the first functional component; and
causing data related to the first functional component instance to be processed by the first service instance using at least the part of resources mapped to the first functional component instance.

28. The method of claim 27, wherein the first acceleration service comprises an event machine, wherein the one or more functional components comprise one or more execution objects, and the data comprises at least one event.

29. The method of claim 27, further comprising:
receiving a request for operating a second functional component of the one or more functional components; and
in response to the request, deploying a second functional component instance for the second functional component within the first service instance.

30. The method of claim 27, further comprising:
in accordance with a determination of scaling out of the first functional component, performing at least one of the following:
mapping an additional part of resources to the first functional component instance based on the resource requirement, and
deploying a further functional component instance for the first functional component within a second service instance, the second service instance being deployed in a second container based on the configuration information related to the first acceleration service.

31. The method of claim 27, further comprising:
in accordance with a determination of removal of the first functional component instance,
removing the first functional component instance from the first container.

32. The method of claim 27, further comprising:
in accordance with a determination of scaling out of the first acceleration service,
deploying a further service instance within a third container based on the configuration information related to the first acceleration service.

33. The method of claim 27, further comprising:
in accordance with a determination of removal of the first service instance,
removing the first functional component instance from the first container, and
removing the first service instance.

34. The method of claim 27, further comprising:
deploying an interface server in a fourth container in the computing environment, the interface server being configured with an interface with a container orchestrator of the computing environment; and
determining, with the interface server, at least one of the following:
the deployment of at least one of the first service instance and the first functional component instance,
removal of at least one of the first service instance and the first functional component instance, and
scaling of at least one of the first acceleration service and the first functional component.

35. The method of claim 34, further comprising:
monitoring a volume of a workload of the first functional component instance; and
wherein at least one of the removal and the scaling is determined at least based on the volume of the workload.

36. The method of claim 34, wherein determining the deployment of the first service instance comprises:
receiving, with the interface server, a request for operating the first functional component; and
in response to the request, determining to deploy the first service instance.

37. The method of claim 34, further comprising:
deploying a service controller instance in a third container in the computing environment, the service controller instance being associated with at least the first service instance;
in accordance with the determination of the at least one of the deployment of the first service instance, the removal of the first service instance, and the scaling of the first acceleration service, causing a first instruction to be communicated from the interface server to the service controller instance; and
in response to the first instruction, performing, with the service controller instance, the at least one of the deployment, the removal, and the scaling in the computing environment.

38. The method of claim 34, further comprising:
deploying a service controller instance in a third container and a service manager instance in the first container, the service controller instance being associated with at least the first service instance;
in accordance with the determination of the at least one of the deployment of the first functional component instance, the removal of the first functional component instance, and the scaling of the first functional component, causing a second instruction to be communicated from the service controller instance to the service manager instance; and
in response to the second instruction, performing, with the service manager instance, the at least one of the deployment, the removal, and the scaling in the first container.

39. An apparatus comprising:
one or more processors; and
one or more memories including computer program code;
wherein the one or more memories and the computer program code are configured to, with the one or more processors, cause the apparatus to:
deploy a first service instance within a first container in a computing environment based on configuration information related to a first acceleration service, the first acceleration service to be associated with one or more functional components;
deploy a first functional component instance for a first functional component of the one or more functional components within the first service instance;
map at least a part of resources of the first container to the first functional component instance based on a resource requirement of the first functional component; and
cause data related to the first functional component instance to be processed by the first service instance using at least the part of resources mapped to the first functional component instance.

40. The apparatus of claim 39, wherein the first acceleration service comprises an event machine, wherein the one or more functional components comprise a plurality of execution objects, and the data comprises at least one event.

41. The apparatus of claim 39 is further configured to:
receive a request for operating a second functional component of the one or more functional components; and
in response to the request, deploy a second functional component instance for the second functional component within the first service instance.

42. The apparatus of claim 39, in accordance with a determination of scaling out of the first functional component, is further configured to:
map an additional part of resources to the first functional component instance based on the resource requirement, and
deploy a further functional component instance for the first functional component within a second service instance, the second service instance being deployed in a second container based on the configuration information related to the first acceleration service.

43. The apparatus of claim 39, in accordance with a determination of removal of the first functional component instance, is further configured to:
remove the first functional component instance from the first container.

44. The apparatus of claim 39, in accordance with a determination of scaling out of the first acceleration service, is further configured to:
deploy a further service instance within a third container based on the configuration information related to the first acceleration service.

45. The apparatus of claim 39, in accordance with a determination of removal of the first service instance, is further configured to:
removing the first functional component instance from the first container, and
removing the first service instance.

46. A computer readable medium comprising program instructions for causing an apparatus to:
deploy a first service instance within a first container in a computing environment based on configuration information related to a first acceleration service, the first acceleration service to be associated with one or more functional components;
deploy a first functional component instance for a first functional component of the one or more functional components within the first service instance;
map at least a part of resources of the first container to the first functional component instance based on a resource requirement of the first functional component; and
cause data related to the first functional component instance to be processed by the first service instance using at least the part of resources mapped to the first functional component instance.
